(19) United States
(12) Patent Application Publication
(10) Pub. No.: US 2019/0012042 A1
(43) Pub. Date: Jan. 10, 2019

(54) METHOD AND DEVICE FOR PRODUCING AN ELECTRONIC SIGNED DOCUMENT

(71) Applicant: THINKCLOUD DIGITAL TECHNOLOGY CO., LTD., Taichung City (TW)

(72) Inventor: Yu-Jen WU, Taichung City (TW)

(21) Appl. No.: 16/026,246

(22) Filed: Jul. 3, 2018

(30) Foreign Application Priority Data
Jul. 10, 2017 (TW) 106123070

(51) Int. Cl. G06F 3/042; G06K 9/00; G06F 3/0488

(52) U.S. Cl. CPC G06F 3/0425; G06F 3/04883; G06K 9/00228; G06K 9/00449

(57) ABSTRACT

A method for generating an electronic signed document is implemented using an electronic device. The method includes displaying, by a display component, an original electronic document; recording, by an image capturing component, a real-time video of a user as the user inputs a set of signature strokes that constitute a signature on the electronic device; generating a screencast of the display component during a time period in which the user is inputting the set of signature strokes, the screencast including the real-time video, the set of signature strokes, and at least a part of the original electronic document; and generating the electronic signed document by embedding the signature and the screencast in the original electronic document.

### CROSS-REFERENCE TO RELATED APPLICATION

This application claims priority of Taiwanese Patent Application No. 106123070, filed on Jul. 10, 2017.

### FIELD

The disclosure relates to a method and a device for generating an electronic signed document.

### BACKGROUND

U.S. Pat. No. 9,798,706 discloses a method for generating an electronic signature. In the method, an electronic device receives a handwritten signature inputted by a signer and a dynamic image that presents a motion of the signer during signing the handwritten signature. Afterward, a web server compiles a data file that includes a representative signal of the handwritten signature and a streaming file of the dynamic image, and executes the data file in the webpage as an electronic signature.

### SUMMARY

One object of the disclosure is to provide a method for generating an electronic signed document.

According to one embodiment of the disclosure, the method is implemented using an electronic device that includes a processor, an image capturing component and an input/output module that includes a display component.

The method includes:

displaying, by the display component, an original electronic document;

recording, by the image capturing component, a real-time video of a user as the user inputs a set of signature strokes that constitute a signature on the input/output module;

displaying, by the display component, the real-time video as the user inputs the set of signature strokes;

recording a screencast of the display component during a time period in which the user is inputting the set of signature strokes, the screencast including the real-time video, the set of signature strokes, and at least a part of the original electronic document; and

generating the electronic signed document by embedding the signature and the screencast in the original electronic document.

Another object of the disclosure is to provide an electronic device that is capable of executing the above-mentioned method.

According to one embodiment of the disclosure, the electronic device includes a processor, an image capturing component, and an input/output module that includes a display component.

The processor is programmed to:
control the display component to display an original electronic document;
control the image capturing component to record a real-time video of a user as the user inputs a set of signature strokes that constitute a signature on the electronic device;
control the display component to display the real-time video as the user inputs the set of signature strokes;
generate a screencast of the display component during a time period in which the user is inputting the set of signature strokes, the screencast including the real-time video, the set of signature strokes, and at least a part of the original electronic document; and
generate the electronic signed document by embedding the signature and the screencast in the original electronic document.

### BRIEF DESCRIPTION OF THE DRAWINGS

Other features and advantages of the disclosure will become apparent in the following detailed description of the embodiments with reference to the accompanying drawings, of which:

FIG. 1 is a block diagram illustrating an electronic device according to one embodiment of the disclosure;

FIG. 2 is a schematic view illustrating implementations of the electronic device;

FIG. 3 illustrates the electronic device displaying an original electronic document;

FIG. 4 illustrates a pop-up window displayed by the electronic device;

FIG. 5 illustrates the electronic device generating an electronic signed document;

FIG. 6 illustrates the electronic device displaying an electronic signed document; and

FIG. 7 is a flow chart illustrating steps for generating an electronic signed document according to one embodiment of the disclosure.

### DETAILED DESCRIPTION

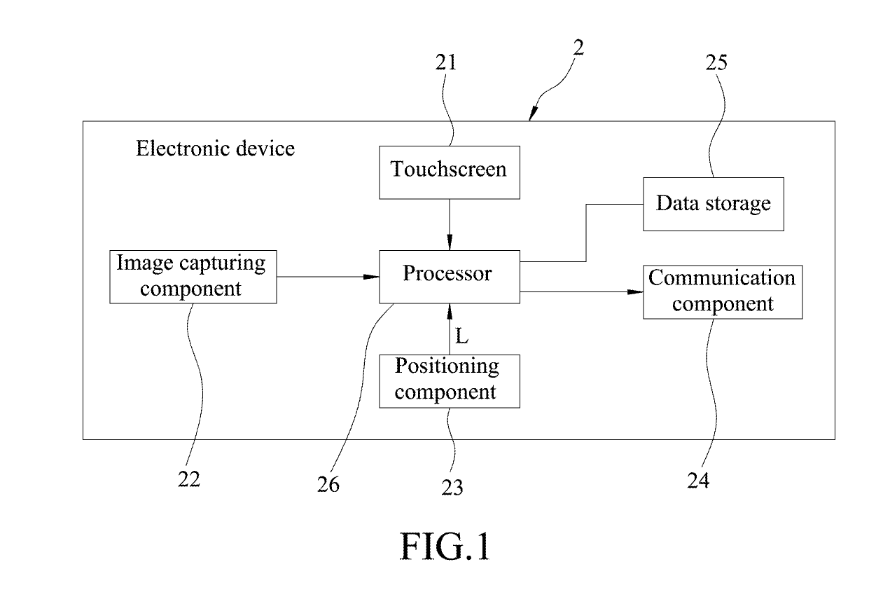

FIG. 1 is a block diagram illustrating an electronic device 2 according to one embodiment of the disclosure.

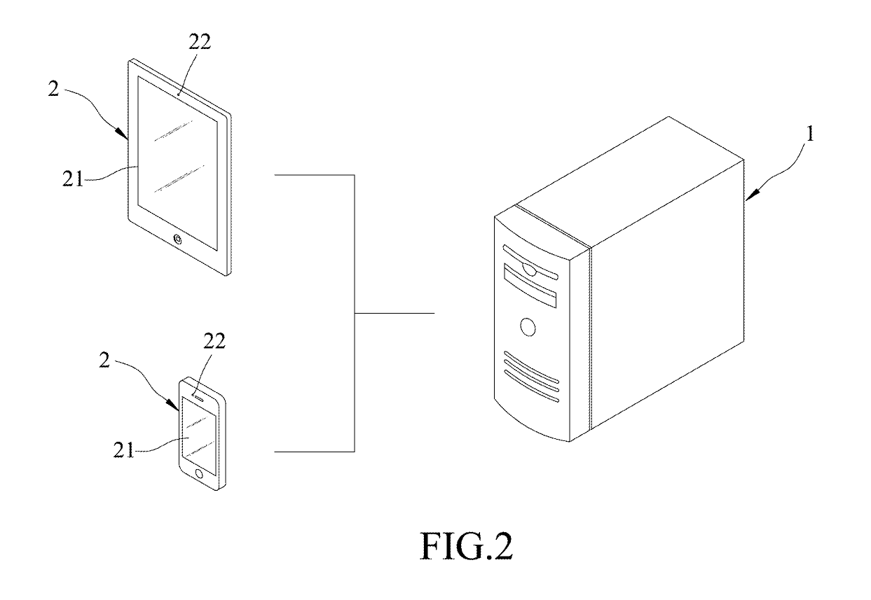

As shown in FIG. 2, the electronic device 2 may be embodied using a personal computer, a laptop, a tablet, a mobile device (e.g., a smartphone), a personal digital assistant (PDA), etc., and includes an input/output module, an image capturing component 22, a positioning component 23, a communication component 24, a data storage 25 and a processor 26.

The input/output module may include an output device such as a display component (e.g., a touchscreen), and an input device such as a writing pad, etc. In this embodiment, the input and output devices are integrated as a touchscreen 21. The image capturing component 22 may be embodied using a physical built-in camera that is built in the electronic device 2 or an external camera connected to the electronic device 2. The positioning component 23 may be embodied using a global positioning system (GPS) component for obtaining a set of location coordinates (L) that indicates a geolocation of the electronic device 2.

The communication component 24 may include a short-range wireless communicating module supporting a short-range wireless communication network using a wireless technology of Bluetooth® and/or Wi-Fi, etc., and a mobile communicating module supporting telecommunication using Long-Term Evolution (LTE), the third generation (3G) and/or fourth generation (4G) of wireless mobile telecommunications technology, and/or the like.

The data storage 25 may be embodied using a non-volatile storage medium such as a hard disk, a flash memory, etc. The data storage 25 stores an operating system (OS) of the electronic device 2 and a software application that can be executed by the processor 26, and at least one original electronic document.

The processor 26 may include, but not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc.

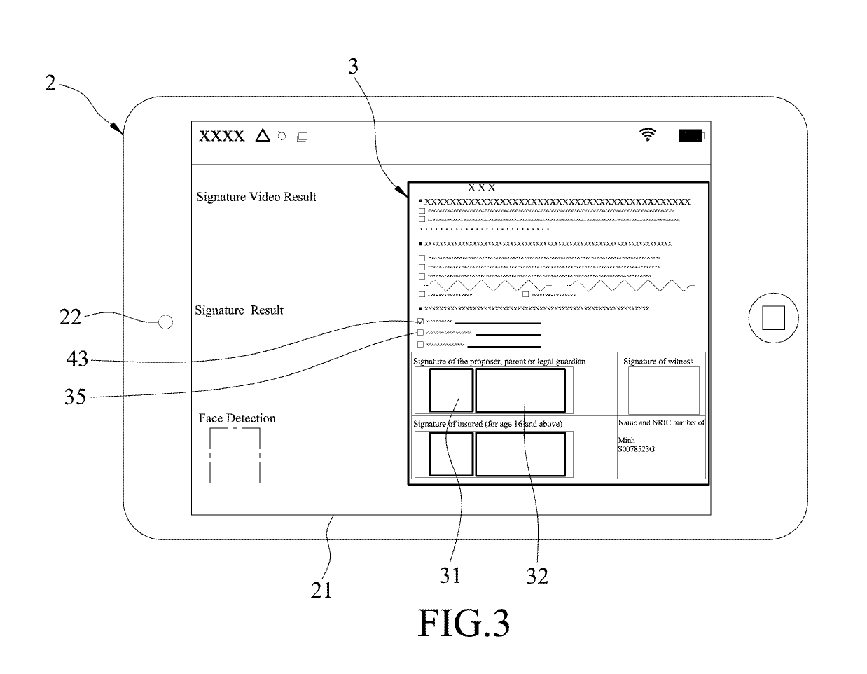

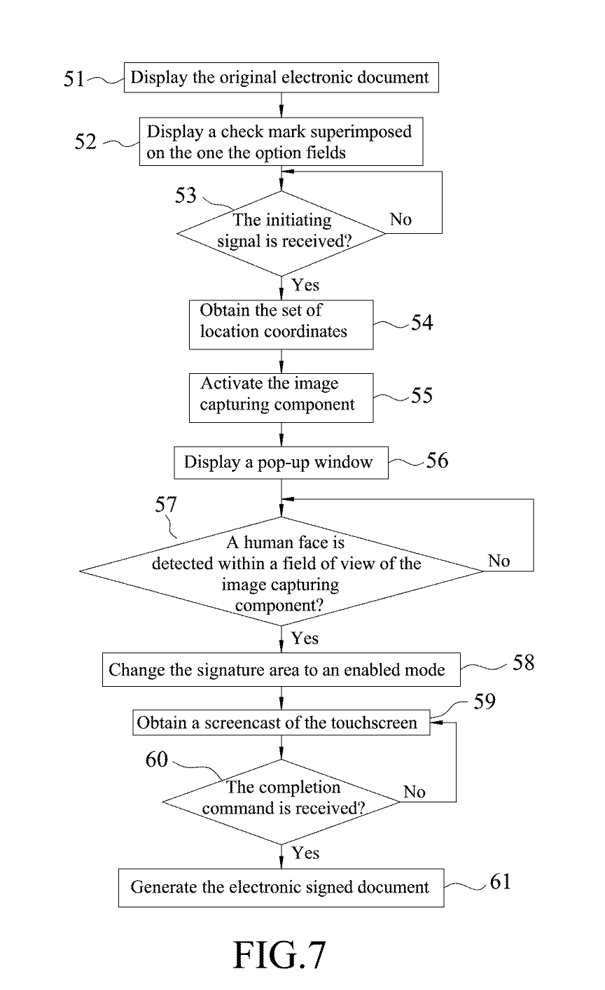

FIG. 7 is a flow chart illustrating steps of a method for generating an electronic signed document from the original electronic document. In this embodiment, as shown in FIG. 3, the electronic device 2 is embodied using a tablet, the input/output module is embodied using the touchscreen 21, and when it is desired for a user to “sign” the original electronic document, the user may operate the electronic device 2 to execute the software application. In response, the processor 26 controls the touchscreen 21 to display the original electronic document in step 51.

In the embodiment of FIG. 3, the original electronic document 3 displayed by the touchscreen 21 includes a signature field 31 and a video field 32. In a case that the original electronic document 3 needs multiple signatures from different parties, additional signature fields and video fields may be present, such as the case depicted in FIG. 3.

In some examples, the original electronic document 3 may further include one or more option fields 35. In this example, the option fields 35 are in the form of check boxes.

Each of the option fields 35 may be associated with a statement (e.g., an agreement by the user, an acknowledgment, etc.).

Before signing the original electronic document 3, the user may operate the electronic device 2 to interact with one the option fields 35 (e.g., to directly touch the touchscreen at a position corresponding to one of the check boxes) in step 52. In response to a user-input signal associated with the one of the option fields 35, the processor 26 may control the touchscreen 21 to display a check mark 43 superimposed on the one the option fields 35. In particular, the user-input signal is generated by the one of the option fields 35 in response to the interaction by the user.

Afterward, when the user is ready to sign the original electronic document 3, the user may operate the electronic device 2 to input an initiating command associated with the signature field 31 (e.g., by directly touching the touchscreen at a position corresponding to the signature field 31).

The processor 26 determines, in step 53, whether the initiating signal is received. In response to the receipt of the initiating signal, in step 54, the processor 26 obtains the set of location coordinates (L) from the positioning component 23. Otherwise, the processor 26 stands by until the initiating signal is received.

In step 55, the processor 26 controls the image capturing component 22 to activate, so as to start obtaining images.

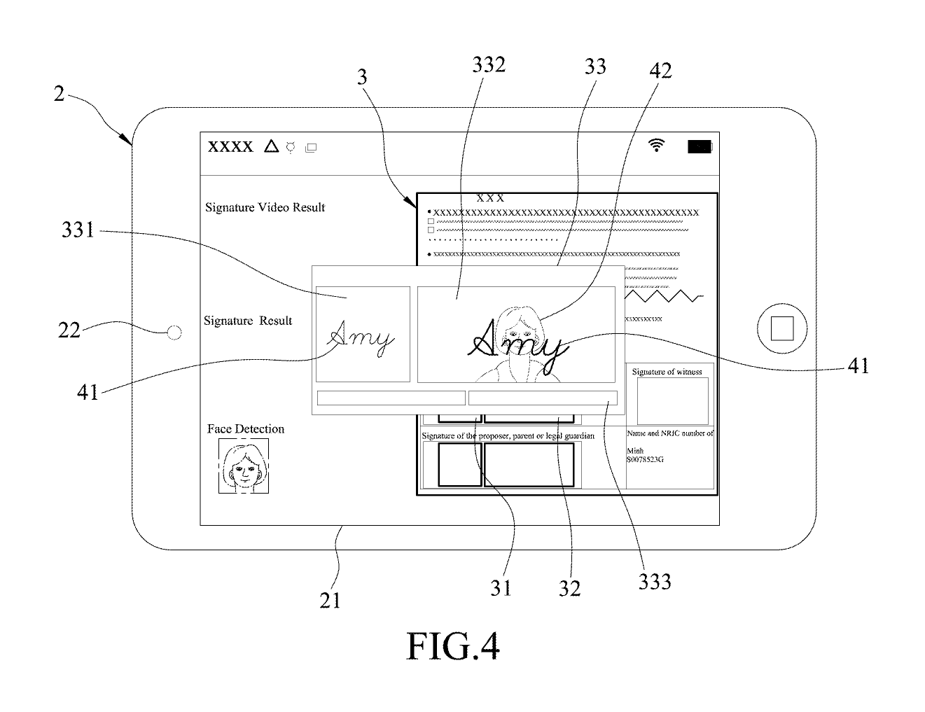

In step 56, the processor 26 controls the touchscreen 21 to display a pop-up window 33 (see FIG. 4) that superimposes a part of the original electronic document 3. As shown in FIG. 4, the pop-up window 33 includes a signature area 331 and a video area 332. It is noted that initially, when the pop-up window 33 is displayed, the signature area 331 is in a disabled mode, that is, the user is not yet able to input the signature in the signature area 331. The video area 332 is programmed to display what is currently being captured by the capturing component 22.

In step 57, the processor 26 determines whether a human face is detected within a field of view of the image capturing component 22. This may be done by the processor 26 performing analysis on the images captured by the image capturing component 22.

When it is determined that a human face is detected within the field of view of the image capturing component 22, the processor 26 deduces that the user (i.e., a signer) is in front of the electronic device 2. In turn, in step 58, the processor 26 changes the signature area 331 to an enabled mode. That is to say, the user is now allowed to input the signature in the signature area 331.

In implementation, the user inputs a set of signature strokes 41, one stroke at a time, to compose a signature in the signature area 331 using a finger or a stylus pen. For each stroke of the set of signature strokes 41, the processor 26 receives a representative signal from the touchscreen 21. The representative signal is embedded with a markup language. For the signature that includes a plurality of signature strokes, the processor 26 receives a plurality of the representative signals respectively representing the plurality of signature strokes, and each of the representative signals is embedded with a respective markup language. In this embodiment, the markup language may be selected from Javascript, Java, Swift, Objecting C, etc.

Additionally, as the user inputs the set of signature strokes that constitute a signature in the signature area 331, the processor 26 controls the image capturing component 22 to start recording the images captured as a real-time video 42. In this embodiment, the real-time video 42 may be in the form of a streaming media in a format selected from the following: H.263, H.264, flash video (.f4v), Realmedia (.rm), Windows Media Video (.wmv), .m4v, Quicktime File Format (.mov), etc. In this embodiment, as it is being recorded, the real-time video 42 is displayed in the video area 332.

As the set of signature strokes 41 is being inputted, the inputted stroke(s) is displayed in the signature area 331. In some embodiments, the set of signature strokes 41 is further displayed in the video area 332, superimposing the real-time video 42 (see FIG. 4).

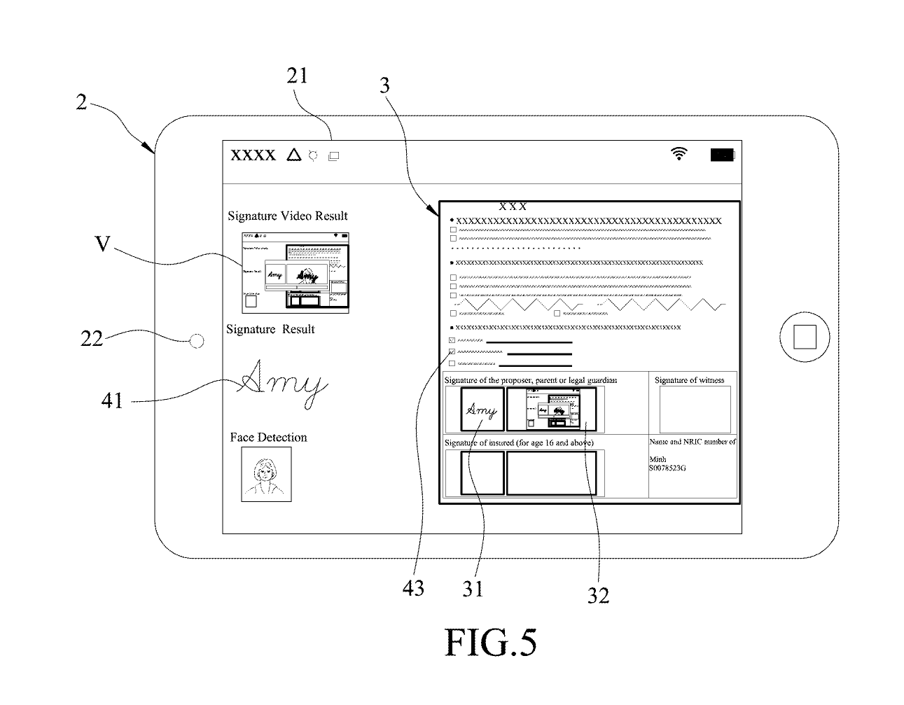

In step 59, when it is determined that the user has started inputting the set of signature strokes 41, the processor 26 starts obtaining a screencast (V) (see FIG. 5) of the touchscreen 21. The screencast (V) records the information that is visible on the touchscreen 21, including the original electronic document 3, the real-time video 42, the set of signature strokes 41, and the pop-up window 33.

After the user has finished inputting the set of signature strokes 41, he/she may operate the electronic device 2 to input a completion command (e.g., by directly touching the touchscreen at a position corresponding to a complete button 333).

When the processor 26 determines in step 60 that the completion command is received, the flow proceeds to step 61, in which the processor 26 generates the electronic signed document. Otherwise, the flow goes back to step 59.

In step 61, as shown in FIG. 5, the processor 26 generates the electronic signed document by embedding the set of signature strokes 41 and the screencast (V) in the original electronic document 3. Specifically, the set of signature strokes 41 is embedded in the signature field 31, and the screencast (V) is embedded in the video field 32.

In some embodiments, in this step, the processor 26 further embeds the set of location coordinates (L) in the original electronic document 3 so as to generate the electronic signed document.

In some embodiments, in this step, the processor 26 further generates an encryption value based on at least content of the screencast (V), and further embeds the encryption value in the original electronic document 3 so as to generate the electronic signed document.

For example, the encryption value may be in the form of a hash value that is generated based on one or more of the following parameters: a geolocation of the electronic device 2; a position of one or more checked marks 43 superimposed on the original electronic document 3; a position of the screencast (V) on the touchscreen 21 (i.e., the position of the video field 32); and a position of the set of signature strokes 41 on the touchscreen 21 (i.e., the position of the signature field 31) as recorded in the screencast (V).

In this way, a hash value thus generated is different from others when one of the above parameters is altered. It is noted that in other embodiments, additional parameters (such as the face of the user, a time at which the real-time video 42 is recorded) may be incorporated in generating the hash value.

In some embodiments, in this step, the processor 26 further obtains a time stamp from a time stamp authority (TSA) 1 (see FIG. 2), and embeds the time stamp in the original electronic document 3 so as to generate the electronic signed document. This is done as a verification that the electronic signed document is generated at a specific time as indicated by the time stamp.

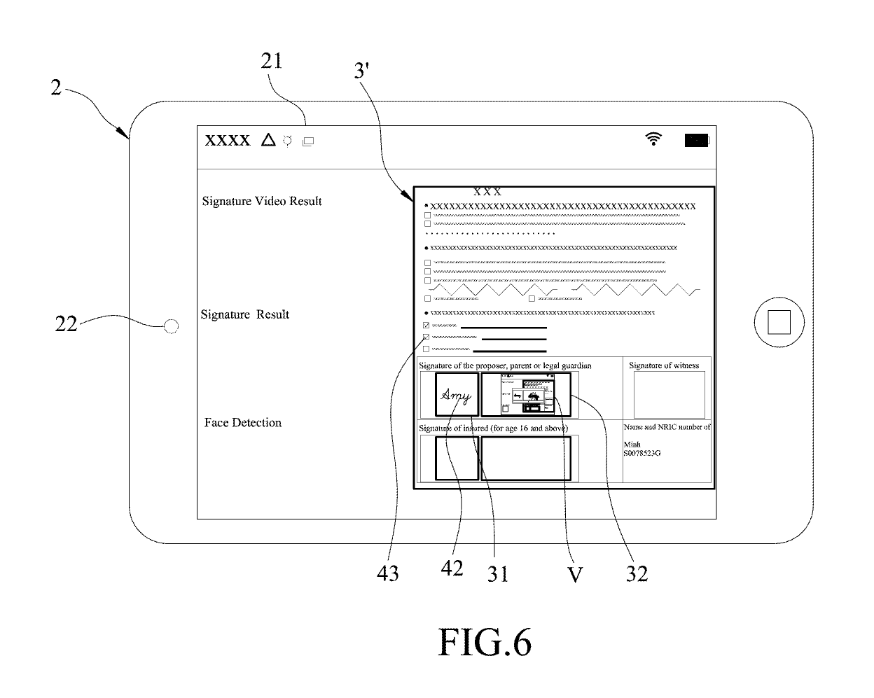

FIG. 6 illustrates an electronic signed document 3′ that is generated using the above method.

To sum up, embodiments of the disclosure provide a method and an electronic device that is capable of generating an electronic signed document 3′ that introduces an association among the user, the original electronic document 3, and the set of signature strokes 41 using the screencast (V). In this manner, it may be established that the set of signature strokes 41 included the electronic signed document 3′ is signed by the user himself/herself.

Additionally, since the screencast (V) includes the set of signature strokes 41, the real-time video 42, the check mark(s) 43, and at least a part of the original electronic document 3, by embedding the screencast (V) instead of the above elements separately, the generation of the electronic signed document 3′ may be implemented relatively easily by the electronic device 2 since fewer elements need to be processed.

Moreover, one or more verification measures (e.g., the screencast (V), the encryption value, and the time stamp) may be selectively incorporated in the electronic signed document 3′ in order to verify that the set of signature strokes 41 included the electronic signed document 3′ is signed or inputted by the user himself/herself, in order to enhance the authenticity.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for generating an electronic signed document, the method being implemented using an electronic device that includes a processor, an image capturing component and an input/output module that includes a display component, the method comprising:
displaying, by the display component, an original electronic document;
recording, by the image capturing component, a real-time video of a user as the user inputs a set of signature strokes that constitute a signature on the input/output module;
displaying, by the display component, the real-time video as the user inputs the set of signature strokes;
recording a screencast of the display component during a time period in which the user is inputting the set of signature strokes, the screencast including the real-time video, the set of signature strokes, and at least a part of the original electronic document; and
generating the electronic signed document by embedding the signature and the screencast in the original electronic document.

2. The method of claim 1, further comprising, after the displaying of the original electronic document:
displaying, the display component, a pop-up window that superimposes a part of the original electronic document, and that includes a signature area for enabling the user to input the set of signature strokes therein, and a video area for displaying the real-time video.

3. The method of claim 2, wherein:
the original electronic document displayed by the display component includes a signature field; and
displaying the pop-up window is implemented in response to a user-input initiation command associated with the signature field.

4. The method of claim 2, further comprising, after displaying the original electronic document:
activating the image capturing component;
determining whether a human face is detected within a field of view of the image capturing component; and
allowing the user to input the set of signature strokes when it is determined that the image capturing component has detected a human face.

5. The method of claim 1, wherein:
the original electronic document displayed by the display component includes a signature field and a video field; and
generating the electronic signed document includes embedding the signature in the signature field of the original electronic document, and embedding the real-time video in the video field of the original electronic document.

6. The method of claim 1, wherein the original electronic document displayed by the display component includes an option field, the method further comprising:
in response to a user-input signal associated with the option field, controlling the display component to display a check mark superimposed on the option field.

7. The method of claim 1, wherein generating the electronic signed document further includes generating an encryption value based on at least content of the screencast, and further embedding the encryption value in the original electronic document.

8. The method of claim 7, wherein the encryption value is generated further based on one or more of the following:
a geolocation of the electronic device;
a position of a check mark superimposed on the original electronic document;
a position of the screencast on the original electronic document; and
a position of the set of signature strokes on the original electronic document.

9. The method of claim 1, wherein generating the electronic signed document further includes obtaining a time stamp from a time stamp authority, and embedding the time stamp in the original electronic document.

10. An electronic device for generating an electronic signed document, comprising a processor, an image capturing component, and an input/output module that includes a display component;
wherein said processor is programmed to:
control said display component to display an original electronic document;
control said image capturing component to record a real-time video of a user as the user inputs a set of signature strokes that constitute a signature on said electronic device;
control said display component to display the real-time video as the user inputs the set of signature strokes;
generate a screencast of said display component during a time period in which the user is inputting the set of signature strokes, the screencast including the real-time video, the set of signature strokes, and at least a part of the original electronic document; and
generate the electronic signed document by embedding the signature and the screencast in the original electronic document.

11. The electronic device of claim 10, wherein said processor is further programmed to, after controlling said display component to display the original electronic document:
control said displaying component to display a pop-up window that superimposes a part of the original electronic document, and that includes a signature area for enabling the user to input the set of signature strokes therein, and a video area for displaying the real-time video.

12. The electronic device of claim 11, wherein:
the original electronic document displayed by said display component includes a signature field; and
said processor controls said displaying component to display the pop-up window in response to a user-input initiation command associated with the signature field.

13. The electronic device of claim 11, wherein said processor is further programmed to, after controlling said display component to display the original electronic document:
activate said image capturing component;
determine whether a human face is detected within a field of view of said image capturing component; and
allow the user to input the set of signature strokes when it is determined that said image capturing component has detected a human face.

14. The electronic device of claim 10, wherein:
the original electronic document displayed by said display component includes a signature field and a video field; and
in generating the electronic signed document, said processor is programmed to embed the signature in the signature field of the original electronic document, and to embed the real-time video in the video field of the original electronic document.

15. The electronic device of claim 1, wherein the original electronic document displayed by said display component includes an option field, said processor is further programmed to:
in response to a user-input signal associated with the option field, control said display component to display a check mark superimposed on the option field.

16. The electronic device of claim 10, wherein in generating the electronic signed document, said processor is further programmed to generate an encryption value based on at least content of the screencast, and to embed the encryption value in the original electronic document.

17. The electronic device of claim 16, wherein the encryption value is generated further based on one or more of the following:
a geolocation of the electronic device;
a position of a check mark superimposed on the original electronic document;
a position of the screencast on the original electronic document; and
a position of the set of signature strokes on the original electronic document.

18. The electronic device of claim 10, wherein in generating the electronic signed document, said processor is further programmed to obtain a time stamp from a time stamp authority, and embed the time stamp in the original electronic document.
